(19) United States
(12) Patent Application Publication
(10) Pub. No.: US 2012/0324057 A1
(43) Pub. Date: Dec. 20, 2012

(54) METHOD FOR PROVIDING A TARGET APPLICATION

(76) Inventor: Alexandre Macris, Courbevoie (FR)

(21) Appl. No.: 13/514,276

(22) PCT Filed: Dec. 7, 2010
(86) PCT No.: PCT/FR2010/052629

§ 371 Date: Aug. 14, 2012

(30) Foreign Application Priority Data
Dec. 7, 2009 (FR) 0958713

(51) Int. Cl. G06F 15/16

(52) U.S. Cl. 709/219

(57) ABSTRACT

The present invention relates to a method for providing a target application on a terminal, said method including the following steps: transferring a deployment application from a server to the terminal, said application being an Internet application; transferring at least one module of the target application from a server, said transfer being triggered by the deployment application; executing the target application, said execution being triggered by the deployment application; and intercepting at least one query coming from the target application.

The present invention relates to a method for providing a target application on a terminal.

Native applications are known, which are executed with the operating system of the to forming a connection between such applications and the hardware elements of the terminal, such an operating system being for example Windows Vista or Linux. A method for providing such applications may comprise a step of downloading the native application from a server followed by a step of installing said application, on the terminal of the user. During said step, the different files constituting the application are in particular stored in the memory of the terminal and an access path to the application is created.

Such a method is conventional but is not very practical because it is not transparent for the user, who needs to perform numerous operations to be able to finally access the application. It is also possible that the number of said operations discourages the user and leads him to give up downloading the native application.

Internet applications are moreover known, which are executed by means of an internet browser, such as Internet Explorer, Mozilla Firefox or Google Chrome for example and a virtual machine, such as Java, Javascript or Flash, enabling the execution of the Internet application even though the constituent elements to thereof are not stored on the terminal. The constituent elements thereof are stored to a large extent on an external server that the terminal can access via an Internet network. To use said application, the terminal needs to permanently communicate with the server storing said elements. The method for providing such an application thus generally comprises a step of accessing the servers accompanied by an authentication of the user.

Such applications require a complete and costly development to be provided to the user, the code of the native applications not being able to be reused, and are thus not available for all the types of existing native applications.

The invention makes it possible to provide an to alternative to the aforementioned Internet applications, by providing a method not very restrictive for the user, and said method being applicable for all types of already existing applications, without substantial modification thereof.

To this end, the invention relates to a method for providing a target application on a terminal, said method including the following steps:
transferring a deployment application from a server to the terminal, said application being an Internet application,
transferring at least one module of the target application from a server, said transfer being triggered by the deployment application,
   executing the target application, said execution being triggered by the deployment application, and
   intercepting at least one request coming from the target application.

Thus, the deployment application enables the execution of all the steps with a view to the use of the target application without any intervention by the user, in particular its transfer. This thus reduces the number of operations to be carried out by the user, or “number of clicks” to obtain an access to the target application and thus increases its interest for the target application.

In addition, conserving the target application on the terminal between two uses is not always justified, the provision thereof being very simple. This can thus the stored on the terminal in the location of the memory of the terminal corresponding to the cache of the browser, and, consequently, be deleted automatically at the end of a predetermined time period. This thus makes it possible to minimise transfers of data during the re-use of the target application but it is thus not necessary to perform a specific uninstall operation when the user no longer wishes to use the target application. Moreover, the target application does not occupy in a needless manner storage space in the terminal.

On account of the interception of requests, the possibilities of modulating the use of the target application, to adapt it as best as possible to the needs of the user, are greater. Thanks to said technique, it is for example possible to provide to the user, in a first instance, a single portion of a target application then, when it so required, to trigger the transfer with a view to the use of additional modules of the target application. One can therefore optimise the use of the target application.

The deployment application is an Internet application, in other words an application that is executed with a virtual machine, such as Java, and an Internet browser, which enables the user to procure the target application without having to download and install beforehand another application forming the deployment application. A deployment application formed by an Internet application is moreover compatible with all operating systems and all browsers and may thus be universally used. It is also not necessary to update such an application, which is updated automatically on-line.

The method according to the invention moreover makes it possible to provide to the user, in a non-restrictive manners numerous already existing target applications without having need to modify them in a significant manner, or even without having to modify them at all, beforehand. The tools for making these is available are in fact independent of the target application chosen by the user. These tools moreover enable numerous target applications to be provided.

The method may also comprise one or more of the characteristics of the following list:
the method comprises a step of executing an interceptor, triggered by the deployment application, said interceptor being able to intercept at least one request coming from the target application, the execution of the interceptor preferably triggering in its turn that of the target application. Thus, it is an interceptor, forming a computer programme separate from the deployment application, that performs the interceptions in the target application, such an interceptor then being able to be separate from an as Internet application and to be a native application, directly in interaction with the operating system of the terminal, which makes it possible to perform the interception of requests more easily by means of known techniques,
the method comprises a step of transferring the interceptor from a server, triggered by the deployment application. The interceptor is thereby transferred onto the terminal without the user having need to carry out an additional action,
the method comprises a prior step of actuation by a user of the terminal of a link situated on a Web page,
the transfer of at least one module of the target application and/or the interceptor is preceded by a step of verification performed by the deployment application with the terminal, and/or a server. In particular, the step of verification may comprise a step of verifying the access rights of the terminal to the module of the target application. The user may thus have access to the target application only if he is registered with an authority and/or if he has paid to benefit from access rights. It may also be envisaged that the deployment application leaves access free only to a portion of the target application, to enable a test of the target application by the user.

Said verification step may also comprise a step of comparison of the module to be downloaded and the module optionally stored on the terminal or a comparison of a file name with the names of the files transferred onto the terminal. Thus, one can avoid pointless transfer operations, and only transfer if necessary the updates of the target application and/or only a part of the modules of the target application,
the method comprises at least one step of redirecting the, or at least one, query to an operating system of the terminal, and/or to the deployment application. Said redirection operations are in particular performed by the interceptor,
the method comprises a step of intercepting a request for displaying the target application and modifying said request so that the target application is displayed in a Web page, in particular the Web page comprising the link. To obtain this result, the modified request is redirected to the operating system. One thus avoids opening multiple windows to enable the user to procure the target application. The user thus benefits from enhanced user comfort of the target application. This also makes it possible to integrate the target application in a particular environment adapted to the user and to his requirements, for example to improve the aestheticism of the environment presented to the user or to disseminate to the user offers in relation with his requirements while he uses the target application,
the deployment application having already transferred to the terminal a base module of the target application, the method comprises a step of intercepting a request for opening a file not belonging to the base module of the target application and a step of transferring the file from a server to the terminal, said transfer being commanded by the deployment application. One then transfers certain files to the terminal only when these are requested by the user. For example, if the latter uses word processing, the drawing module may not be transferred to the terminal during a step of initial transfer, then be transferred to the terminal uniquely if said module is requested by the user. This makes it possible to optimise the storage space reserved for the application on the terminal and to minimise the transfer time necessary so that the user can begin to use the target application,
the method may also comprise a step during which one commands the carrying out of an action of the target application as a function of a link activated on a Web page. This enables a communication of the target application with its environment.

The invention also relates to a computer program enabling a target application to be provided on a terminal, said program comprising software instructions for:
commanding the transfer of at least one module of the target application from a server on which it is stored,
commanding the execution of an interceptor able to intercept at least one request coming from the target application,

such a program forming an Internet application.

The invention also relates to a device comprising a memory storing the computer program according to the invention as well as an interceptor able to intercept at least one request coming from the target application.

Such a device is for example a terminal, a server or a set of servers.

Optionally, the target application is also stored in the memory of the device.

The invention also relates to a system comprising a terminal connected by a network to at least one server or a set of servers forming a device according to the invention.

The invention will be better understood on reading the description that follows, given uniquely by way of example and made with references to the drawings in which:

FIG. 1 represents a system enabling the execution of a method according to an embodiment of the invention,

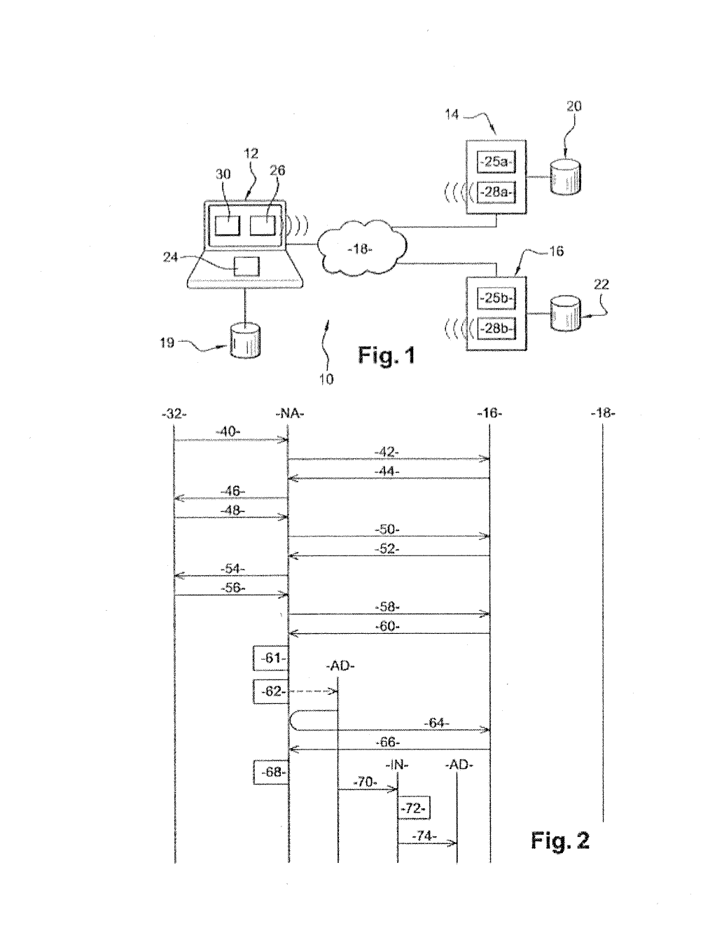

FIG. 2 is a diagram representing an initialisation of a method according to an embodiment of the invention,

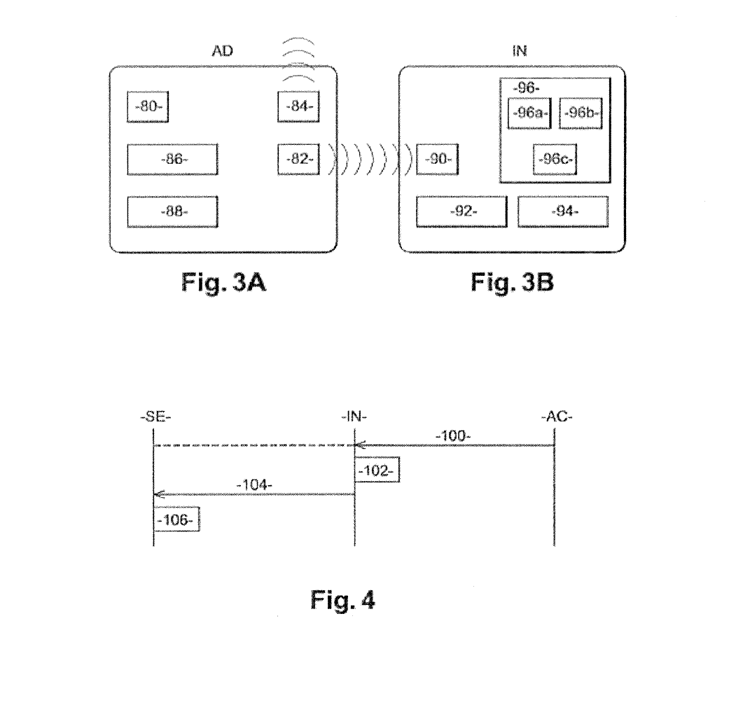

FIGS. 3A and 3B are diagrams of the respective structures of a deployment application and of an interceptor used for the implementation of the method according to an embodiment of the invention,

FIGS. 4 to 6 are diagrams representing steps of the method that take place during use by a user of the target application.

In FIG. 1 is represented a system 10 comprising a terminal 12 and a plurality of servers 14, 16 connected to the terminal through the intermediary of a network 10, such as the Internet network.

The terminal 12 and the servers 14, 16 each comprise data storage means, respectively 19, 20, 22, such as a memory, as well as execution means respectively 24, 25a, 25b, such as a processor, such means enabling in particular the execution of applications on said devices and the memorising of certain data in the respective data storage means of each of said devices. Each of the elements of the system also comprises means of communicating 26, 28a, 28b with the other elements of the system enabling the various elements to communicate with each other via the network.

The terminal 12 also comprises input-output means 30 enabling interaction with a user. Such means comprise in particular a keyboard, or a mouse, to enable the user to command the terminal and a screen or a loud-speaker to enable the latter to receive the information or the terminal.

The terminal 12 comprises an operating system SE forming an interface with the user and making it possible to execute all of the native applications situated on the terminal, in particular stored in the storage means thereof. Such an operating system is for example Windows Vista or Linux. The terminal 12 also comprises a native application forming “browser” NA, which makes it possible to communicate with other entities via the Internet network. Known browsers are for example Internet Explorer or Mozilla Firefox. The operating system and the browser are executed on the terminal by means 24.

The server 14 comprises in its storage means a deployment application, which will be detailed hereafter in the description and the server 16 comprises in its storage means an interceptor, also described in greater detail hereafter, and the target application that the user wishes to access.

Before being placed in the memory 22 of the server 16, the target application is manually configured to be adapted to the execution in the context of the method. The size of the window is for example configured. The file of parameters is then saved in the memory of the server 16 with the other files relative to the target application. The files can be saved in compressed form.

The method for providing an application intended for the terminal 12 will now be described, such a method being performed by means of the system as described. The initialisation of said method will firstly be described.

During a first step 40, the user 32, having access to the terminal 12, commands the latter to display a Web page enabling the target application to be accessed. He performs said step by clicking on a link of a search engine displayed by means of the browser, for example, or by keying in the address of the Web page by input-output means 30 in the browser interface. Said Web page is displayed by means of a browser executed by the processor of the terminal.

Following said step, the browser NA of the terminal 12 requires the loading of the Web page with a first server, for example the server 14, during a step 42. This communication with the server is performed by communication means 26, 28a of the terminal and of the server and of the network 18. The server 14 responds to the query of the browser NA by providing to it the Web page requested, stored in its storage means 20, during a step 44. The page is displayed on the screen of fhb terminal 12, during a step 46, thanks to the browser which enables it to be presented to the user.

Such a Web page generally has a fink to command the transfer and the execution of a target application, for example a word processing application, a game or an application of any other type. During a step 18, the user that wishes to use the target application clicks on the link and activates it.

The browser NA sends a message to the server 11 to indicate to it that the user 32 has activated the link during a step 50 and the server returns during a step 52 an authorisation message intended for the user 32, which the terminal returns to the user, during a step 54. Steps 50-54 make it possible to obtain the confirmation of the user proving that he indeed wishes to obtain the target application and avoid any pointless operations for providing the target application.

If the user 32 still wishes to access the target application, he activates a link to signify his agreement, for example by clicking on a button in the browser interface, during a step 56.

The browser then signifies to the server 14 that the user has activated the link during a step 58. In response, the server 14 initiates the transfer, to the terminal 12, of a deployment application AD, during a step 60. The browser then stores a portion of the target application in the storage means of the terminal 12, in the location corresponding to its “cache”, which is a memory in which the files are stored in a temporary manner, during a step 6. Such a step is a conventional step in the case of transfer by means of the browser. Following its saving, and also in a conventional manner, the browser commands the execution of the deployment application on the terminal 12, during a step 62.

The deployment application AD is an Internet application that is executed by means of a virtual machine, for example Java, such a virtual machine being installed on the terminal 12, and the browser of the terminal 12, during the step 62. It is executed more particularly in the context of the browser. In the embodiment described, said application is a Java applet.

The structure of the application according to this embodiment of the invention is represented in a schematic manner in FIG. 3a. Such an application comprises a user interface unit 80, able to present an interface to the user and to transform the actions of the user on the command interface. Said interface is loaded in a Web page, given that the application is executed by means of an Internet browser. It also comprises a unit 82 for communicating with another application, i.e. an interceptor IN, which will be detailed hereafter, and a unit for communicating 84 with the browser and the operating system, formed by a Java application of known type.

It moreover comprises means of managing the cache 86 of the browser making it possible to control the presence of files relative to the target application in the cache of the browser and transfer management means 88, the usefulness and the functioning of which will be detailed hereafter.

Once the deployment application AD has been transferred onto the terminal 12, it sends, without intervention of the user, a message to a second server 16 to command the transfer from said server 16 of the target application AC and an interceptor IN to the terminal, during a step 64 performed through the intermediary of the browser acid communication means 26. Said step is performed in particular by transfer management means 88 of the deployment application AD, which indicate what are the files of the target application to transfer from the server 16 and by the communication unit 84 of the deployment application to the browser making it possible to transmit the query constructed by the transfer manager to the browser.

In response to said query, the server 16 transfers both the interceptor IN and a base module of the target application forming a portion of the target application to the terminal during a step 66.

The base module of the target application comprises for example text lay out functions in a word processing, but not those relative to drawings or tables. The target application AC and the interceptor IN are native applications, which are executed directly with the operating system of the terminal 12, thanks to which different applications such as the browser thereof is executed.

The operating system saves, during a step 68, the target application AC and the interceptor IN at the location corresponding to the cache of the browser in the storage means of the terminal, in a conventional manner.

The structure of the interceptor as saved in the terminal 12 will now be described with reference to FIG. 3B. Such an interceptor comprises a unit 90 for communicating with the deployment application AD, as well as a target application executer 92, which puts in place the context of execution of such an application, i.e. the data enabling the execution of the target application. It also comprises an injector 94 making it possible to connect in a known manner the interceptor to the target application. Finally, the interceptor also comprises facility controllers 96a, 96b, 96c, making it possible to connect a function called by the target application to an action to be executed by the interceptor. In this example, the interceptor comprises three facility controllers: that of the windows 96a, that of the accesses to the files of the target application 96b and that of the system events 99c.

It will be noted that the communication units 82, 90 function by means of known inter-process channels such as sockets, the deployment application and the interceptor not being executed in the same context.

The deployment application AD then commands the execution of the interceptor IN during a step 70, by means of the communication unit 82. Once its execution launched, the interceptor IN creates the environment for executing the target application during a step 72. Then, the interceptor commands the execution thereof by means of the unit 92 and is injected into the context of the target application during a step 74, by known techniques and by means of the injector 94. The target application is now ready to be used by the user.

In FIGS. 4 to 6 will now be described sequences of the method according to the embodiment described in FIG. 2, during the execution of the target application.

FIG. 4 represents more particularly the exchanges between the different elements of the terminal 12, during the opening of the target application.

During a step 100, the target application AC emits a request intended for the operating system SE of the terminal 12. Said request is a request to the operating system so that said system opens a display window for the user interface of the application on the screen of the terminal.

On account of the in of the interceptor in the application, it intercepts the request intended for the operating system and modifies it during a step 102, according to the prescriptions of the facility controller 96b. The interceptor is in particular programmed to add details on the location of the display window of the target application, and indicate that this must be located in the Web page displayed by the browser and on which the user has activated the link.

The interceptor IN then transmits the modified request of the target application AC to the operating system during a step 104. The operating system SE with the help of the browser then proceeds during a step 106 to display the window of the target application AC.

The fact that the parameter of window size has been configured beforehand manually makes it possible to enhance user comfort, because the window of the target application may thus be of size adapted to the size of the display space devolved on the Web page. A prior configuration of the target application is not however obligatory.

The window is then displayed in the Web page, which enables the target application to be connected to the Web site distributing it and to display elements, for example commercial elements, which the user can view at the same time as he uses the target application AC.

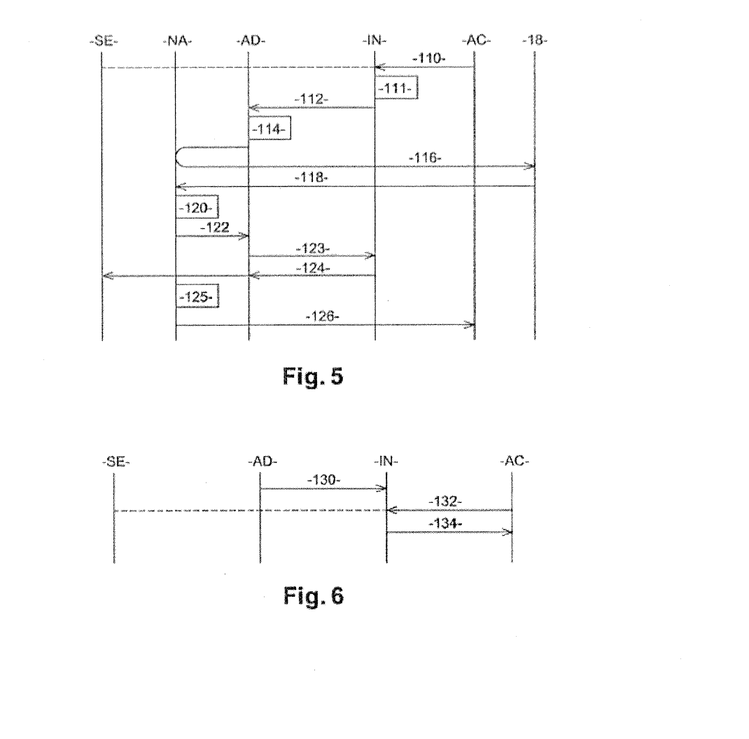

With reference to FIG. 5, the exchanges and interactions between the different components of the system, when the user requires the use of an additional module not saved on the storage means of the terminal, will now be described.

During a step 110, following the request of the user, the target application AC emits a request intended for the operating system SE for the opening of the file of the target application AC, said file is not saved in the storage means of the terminal.

The interceptor IN intercepts the request and verifies if said file has already been transferred into the terminal, by means of said facility controllers, programmed to do this, during a step 111. Then, if said file has not already been transferred into the terminal, it transmits the request during a step 112 to the deployment application AD by means of respective communication units 82, 90. Otherwise, the request is directly transferred to the operating system. This case is not represented in FIG. 5.

During a step 114, the deployment application AD then verifies that the requested file is available on the server 16, by cache management means 86 having a list of available files and in cooperation with the browser.

In this case, it then sends, during a step 116, a request to the server 16 through the intermediary of the browser NA to obtain a module comprising the missing file. Said step is performed by the deployment application AD by transfer management means 88 determining what files need to be transferred from the server and the unit for communicating with the browser 82. During a step 118, the server 16 returns to the terminal 12, in particular to the browser, the missing additional module. Such a module corresponds for example to an additional function of the target application.

The browser NA then saves the module in the cache of the browser, during a step 120 and emits a message to the deployment application AD to indicate to it that the downloading is terminated. The deployment application then communicates with the interceptor to indicate to it that the file is available, during a step 123. Said communication is also performed via the communication unit 82. The interceptor IN then transmits the request for opening the file to the operating system during a step 124. During a step 125, the operating system then opens the file requested by the target application and responds to the target application AC, during a step 120. Said target application can then respond to the request of the user and continue its operation in a normal manner.

The exchanges between different elements of the terminal 12 during the closing of the target application AC will now be described with reference to FIG. 6.

To close the target application, the user can activate a link of the Web page provided by the browser and displaying the target application. He may for example click on an icon representing a cross in said Web page.

When this happens, the deployment application AD is informed that the link has been activated by the user, in particular with the user interface unit 80.

The deployment application AD then sends a message to the interceptor IN to inform him that the link has been activated by the user, by means of the unit for communicating with the interceptor 84 and during a step 130.

Then, during a step 132, when the target application sends an event questioning request, a periodic request sent to the operating system in a known manner, the interceptor IN intercepts said query. Since the closing signal of the target application AC has been received from the deployment application AD, the interceptor IN then responds directly to the target application by the command “close the application”, according to what is prescribed by one of its facility controllers.

Such a method thus makes it possible to use the target application in a simple manner for the user, without however having need to modify the code relative to the target application.

It will be noted that the invention is not limited to what has been described above.

For example, the system may not conform to what has been described above. The number of servers may for example be different to that which has been described, the deployment application, the interceptor and the target application being able for example to be provided on a same server. The network may also be a local network and not the Internet network.

Moreover, the deployment application may be different to what has been described. It may for example not comprise cache management means. Moreover, it may comprise additional modules to what has been described, for example a module enabling the redirection of the user to a Web site on which he has to identify himself when he intends to use a particular function of the target application or a module making it possible to verify that the access rights of the user are still in force in this same case.

It may also comprise means of managing updates of the application able to compare the files stored in the cache of the browser and the files that are on the server and to verify if it is necessary to transfer to the terminal updated files relative to the files that said terminal already possesses.

The interceptor is not limited to what has been described. It may in particular comprise additional facility controllers when it is necessary to intercept other functions of the application than those already described.

The method is not, limited either to what has been described. As has been made clear above, it is possible that the interceptor is able to modify other functions than those described or uniquely one function among those described or among others. The interceptor can intercept all of the requests coming from the target application by retransmitting certain functions to the operating system without modifying them or only intercepting certain requests.

It is also possible that the deployment application and/or the interceptor and/or the target application is act memorised in the cache of the browser. Moreover, the interceptor may not be transferred to the terminal at each initialisation of the target application but the deployment application can firstly verify if it is stored on the terminal.

In the same way, the interceptor and the deployment application are not necessarily transmitted during the same step. All the target application can on the other hand be transmitted using a single and same step.

The steps 50 to 54 are also optional, even though so they are preferential to guarantee the agreement of the user.

1.-10. (canceled)

11. A method for providing a target application on a terminal, said method including the following steps:
transferring a deployment application from a server to the terminal, said deployment application being an Internet application
executing the deployment application by means of a virtual machine and of an Internet browser;
triggering by the deployment application the transfer of at least one module of the target application from a server,
triggering by the deployment application the execution of the target application, and
triggering by the deployment application the execution of an interceptor configured to intercept a display request originating from the target application and to modify said display request so that the target application is displayed in a Web page.

12. The method as claimed in claim 11, wherein execution of the interceptor is performed before the execution of the target application.

13. The method as claimed in claim 12, further comprising triggering by the deployment application the transfer of the interceptor from a server.

14. The method as claimed in claim 11, further comprising verifying the deployment application at the terminal and/or at a server.

15. The method as claimed in claim 11, comprising intercepting by the interceptor a request originating from the target application intended for an operating system of the terminal, and redirecting by the interceptor said request to the deployment application.

16. The method as claimed in claim 15, comprising intercepting by the interceptor a request originating from the target application for opening a file, and commanding by the deployment application the transfer of the file from a server to the terminal if the file does not belong to a base module of the target application already transferred to the terminal.

17. The method as claimed in claim 11, further comprising carrying out action by the target application as a function of a link activated by a user in a Web page.

18. Device comprising a memory storing software instructions configured to perform a process of providing a target application on a terminal, wherein the process comprises:
triggering the transfer of at least one module of the target application from a server,
triggering the execution of the target application, and
triggering the execution of an interceptor configured to intercept a display request originating from the target application and to modify said display request so that the target application is displayed in a Web page.
